(19) United States
(12) Patent Application Publication
(10) Pub. No.: US 2013/0322437 A1
(43) Pub. Date: Dec. 5, 2013

(54) METHOD AND APPARATUS FOR REMOVING BGP STATE FROM NETWORK EDGE ELEMENTS

(71) Applicants: Robert Raszuk, San Mateo, CA (US); Ichiro Fukuda, San Mateo, CA (US)

(72) Inventors: Robert Raszuk, San Mateo, CA (US); Ichiro Fukuda, San Mateo, CA (US)

(21) Appl. No.: 13/485,009

(22) Filed: May 31, 2012

(51) Int. Cl. H04L 12/56

(52) U.S. Cl. 370/389

(57) ABSTRACT

A core network aggregates control information and generates forwarding information at a route controller distinct from each of a plurality of provider edge (PE) routers along the edge of the core network. A network controller generates forwarding state indicative of a next hop router along the edge. Message traffic traversing the core identifies a destination PE, or exit interface, router from forwarding state pushed to the PE routers by the network controller. Aggregation of the forwarding information at the router controller and generating the forwarding state at the network controller removes control plane from the edge (PE) routers of the core to eliminate the need for BGP at the edge routers and provide a BGP free edge. This simplifies the edge architecture as well as directly accelerates the new service delivery by any given autonomous system.

### BACKGROUND

Modern computer networks bring an ever increasing assortment of protocols and switching devices (i.e. routers, switches, hubs, etc.) for transporting various types of data between providers and users. Many enterprises often employ private subnetworks, or LANs, at individual sites or campus environments, that connect to other satellite locations via a wide area network (WAN). Often, such a WAN is collectively and/or conveniently referred to as the Internet, but in reality the physical network is comprised of Internet service providers each operating an autonomous system (AS), defined as a commonly controlled interconnection adhering to a single and clearly defined routing policy, such as that defined in RFC 4271.

The AS is sometimes referred to as a core network, and individual LANs that connect to it as customer networks. A gateway to each network is referred to as a provider edge (PE) or customer edge (CE) router, respectively. Since the gateway routers denote the first decision point for message traffic entering that AS, individually traffic packets may be designated or flagged for particular treatment, rather than passed through to the network fabric. One such approach is to invoke the Border Gateway Protocol (BGP) for managing message traffic traversing the core via encapsulation or tunneling to the remote PE router from which the message traffic (i.e. packet) will exit the core

The Border Gateway Protocol (BGP) is a path vector protocol which acts as a core routing protocol of the Internet. BGP is an important Internet protocol used by ISP to establish routing between one another. It maintains a table of IP networks or prefixes and assigns network reachability to autonomous systems; as a result it is indirectly used by the Internet users. BGP is even more important for newer services such as L3VPNs and L2VPNs. The iBGP protocol is used among the routers in autonomous systems to command the internal routers.

### SUMMARY

A core network aggregates control information and generates forwarding information at a route controller distinct from each of a plurality of provider edge (PE) routers along the edge of the core network. A network controller generates forwarding state indicative of a next hop router along the edge. Message traffic traversing the core identifies a destination PE, or exit, router from forwarding state pushed to the PE routers by the network controller. Aggregation of the forwarding information at the router controller and generating the forwarding state at the network controller removes control plane from the edge (PE) routers of the core to eliminate the need for BGP at the edge routers and provide a BGP free edge.

In a computer network such as the example AS disclosed herein, the AS is maintained by an ISP according to policies set by the ISP. Provider edge (PE) routers denote a network boundary, or edge, to the AS, and mark ingress and egress points, typically to customer edge (CE) routers serving users. The edge surrounds a core, which is a mesh of switching entities transporting message traffic packets. Forwarding state (or routing state) defines, for a packet arriving at an ingress PE router, the egress PE router at a remote edge. Typically, BGP identifies the forwarding, or next hop PE router, and a tunneling or encapsulation mechanism employed for the path through the core to the egress PE router. Thus, the forwarding state is concerned with only the destination PE router defining the next hop and egress point from the network.

In the configurations disclosed herein, the edge router architecture changes by eliminating the need to store or parse all BGP messages by the edge router or the edge switch. Instead the EBGP sessions and in particular BGP update messages are transparently transiting the edge nodes for handling by BGP route controllers residing within the domain. A further capability invoked permits the edge network element's (PE) forwarding plane is capable of being programmed by the external network controller. One of the mechanisms which can be used to program a network element can be accomplished by the use of OpenFlow protocol.

In the core network, PE routers define an edge where message traffic enters and exits the core via ingress and egress PE routers, as defined by a path traversing the core. The path identifies a “next hop” PE router, as determined by the forwarding state (also referred to as “routing state”). In conventional approaches, BGP may manage the edge and even the internal core for supporting the forwarding state that defines the egress (i.e. next hop) router for a packet (message traffic) traversing the core. Maintaining BGP around the core for a large number of routes can require substantial resources of the PE routers. Configurations discussed further below remove the forwarding state maintained by BGP from the PE routers, thus permitting lower cost hardware to function as PE routers because control plane functions performed using the forwarding state have been removed to the network controller.

Configurations herein are based, in part, on the observation that conventional approaches to BGP routing compute and store forwarding state at each respective PE. Unfortunately, conventional approaches suffer from the shortcoming that each PE router therefore maintains a substantial number of routes and may need to be reconfigured at each service change affecting the PE routes identifying the next hop egress router from the core. Configurations herein substantially overcome the above-described shortcomings by removing the BGP overlay from running on the edge.

In conventional approaches, edges typically run BGP which tells the forwarding logic in the edge to which remote exit point the packets should be sent, sometimes referred to as upper control plane. By way of background, a lower control plane is typically is built by an IGP instance (OSPF, ISIS)+if required some extensions for signaling, which is responsible for constructing data plane paths via the network. Those paths are edge to edge through the core.

In contrast, the disclosed configurations herein remove the control state and has potential to reduce amount of forwarding state from the edge and perform BGP operations from remote routing entities such as a route controller and network controller. The route controller aggregates the information and passes it to the network controller. The network controller programs the edges with corresponding mappings of external routing information to ingress-egress points in the network

Configurations herein identify the forwarding information at the PE routers, and redirect the BGP control plane messages to the route controller. The route controller aggregates the control plane messages from each of the PE routers in the core network The route controller can aggregate the information and passes it to the Network Controller. Then Network Controller programs the edges with corresponding mappings of external routing information to ingress-egress points in the core network. The resulting simplified edge architecture allows relaxed requirement for every edge network element to be fully capable of handling any new service or extension to already offered services, and reduces or eliminates the need to process, store and maintain effectively the same set of control plane data across large number of edge platforms. Further enhancements eliminate the need to perform the same control plane tasks across number of edge network elements, and provide for a lower cost of edge infrastructure (commodity switches).

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a context diagram of a network environment suitable for use with configurations herein;

FIG. 2 is a flowchart of routing state in the environment of FIG. 1;

FIG. 3 is a block diagram of routing state data flow as in FIG. 2;

FIG. 4 shows routing information computed for the data flow in FIG. 3;

FIG. 5 shows a shim employed in the configuration of FIG. 4; and

FIGS. 6-8 are a flowchart of routing state programming as in FIGS. 3-5.

### DETAILED DESCRIPTION

Configurations described below disclose a method for propagating routing state in a network by receiving control plane data from a plurality of edge routers, such that the control plane data includes routing decision information applicable to network edges. The network controller programs the PE routers with the forwarding state indicative of the edge routes, thereby relieving the PE routers from this operation. The PE router transmits the identified control plane message to a route controller, in which the route controller is for aggregating control plane information received by the PE router, and the control plane information. The route controller identifies, for each route, a path between the PE router and a remote PE router at the egress point on the edge.

In BGP (Border Gateway Protocol), a next hop identifies a remote PE router. The PE routers employ encapsulation on the path through the core, therefore the PE router identifies the remote PE router as the next hop, and intermediate switching entities in the core employ the encapsulation for transports packets across the core.

Conventional approaches employ either BGP throughout the core, thus each router or other switching entity retains and invokes switching logic, or maintain BGP only at the edge routers, and allow the core to remain BGP free. In approaches disclosed below, the BGP routing control plane, or routing state, is maintained by a route controller that relieves the need for individual PE routers to maintain routing state. The result is that control plane routing state is removed from the PE core routers such that the PE routers need only be concerned with the forwarding, or data plane, thus allowing simpler and lower cost hardware to be employed around the edge. Another advantage is to observe that any new feature or new service now does not need to result in upgrade of the control plane on a large number of edge routers or switches, but only one or several route controllers in any given network.

This routing information for defining the remote PE router is often referred to as “routing state” or “forwarding state.” The forwarding state, therefore, indicates a remote PE router defined as the “next hop” route for a particular routing decision. In contrast to conventional approaches, which store the forwarding state at each PE router or switching device, configurations herein redirect the routing state information to a network controller for maintaining the routing state. A route controller aggregates the information to Network Controller. Then Network Controller programs the edges with corresponding mappings of external routing information to ingress-egress points in the network.

In operation, a route controller receives control information from the PE routers, which is typically sent by the CE routers served by (connected to) the PE router. The route controller computes forwarding information from the control information provided by the PE routers, and sends the forwarding information to the network controller. The network controller generates the routing state defining the control plane, and pushes the routing state to the PE routers, thus relieving the PE routers from computing the routing state. The routing state indicates the next hop PE router on a destination side of the core network, and allows the core network to identify and encapsulate messages on physical path through the core to the next hop PE router.

In particular configurations, such forwarding may be referred to as “BGP free edge” because the edge (PE) routers are relieved of the need to maintain routing state. Instead, routing state is removed to the route controller and then a subset of it passed to the network controller for dissemination and programming of the individual PEs.

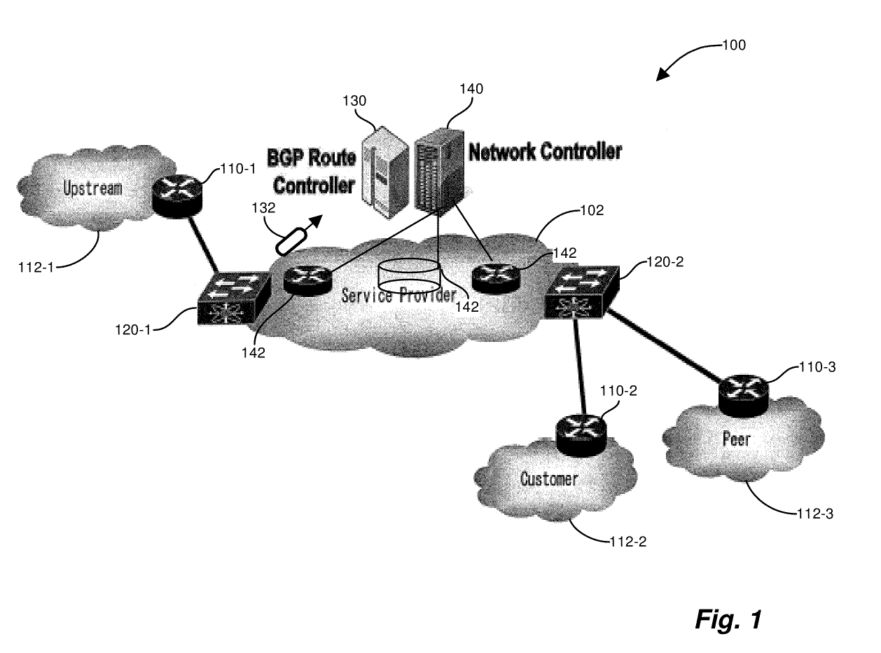

FIG. 1 is a context diagram of a networked environment suitable for use with configurations herein. Referring to FIG. 1, in an IP network environment 100, a core network 102 provided by an Internet service provider interconnects and performs transport operations on behalf of customers. A customer edge (CE) router 110-1 . . . 110-3 (110 generally) denotes a gateway to a customer network 112-1 . . . 112-3 (112 generally) for which transport services are provided. The customer networks 112 include an upstream network 112-1 providing a service, and downstream networks corresponding to the customer 112-2 and one or more peer networks 112-3. Each of the CE routers 110 connects to the core network 102 via a provider edge router 120-1 . . . 120-2 (120 generally) that denotes a gateway into the provider network 102, and operates as an ingress or egress point for message traffic traversing the core from an ingress PE router to an egress PE router via a next-hop routing decision as disclosed herein.

In the example shown in FIG. 1, the core network 102 is an IP network including a plurality of routing entities 142 (i.e. routers, switches, hubs, etc.) for conventional routing and forwarding via routing tables. Unlike conventional routing and forwarding, however, which require a routing table lookup and next “hop” computation at each router, BGP based routing can be more intensive. IP performs lookup on much smaller FIB or LFIB tables as opposed to all BGP scale FIBs which could consist of millions of entries. In IGP or LDP, typically the maximum size is proportional to the number of PEs in the network.

In the configurations herein, the PE routers 120 forward the control plane information as messages 132 to an external routing entity such as the route controller 130. This relieves the PE routers 120 from the overhead associated with BGP lookups and routing and effectively separates control plane and data plane information at the PE router 120.

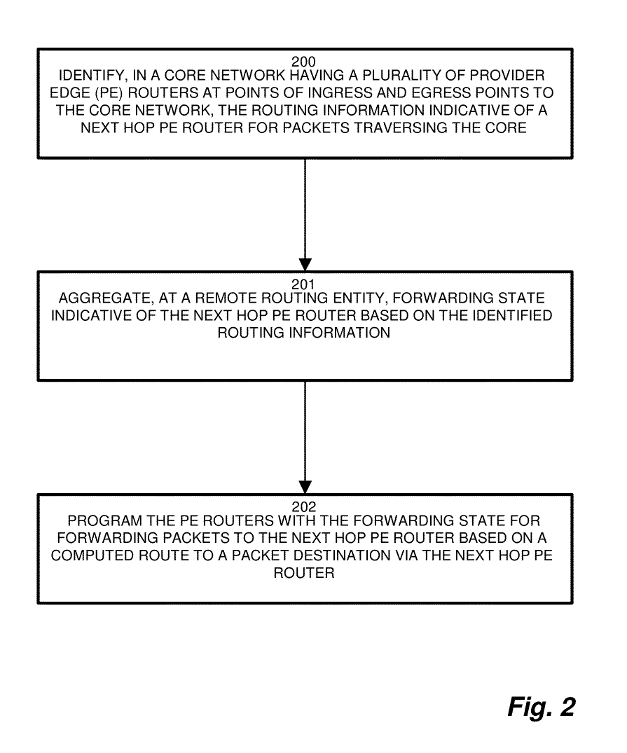

FIG. 2 is a flowchart of routing state in the environment of FIG. 1. Referring to FIGS. 1 and 2, the method for storing routing state information as defined herein includes, at step 200, identifying, in a core network having a plurality of provider edge (PE) routers at ingress and egress points to the core network, the routing information indicative of a next hop PE router for packets traversing the core. Generally, BGP routing indicates, for a packet traversing the core, a next-hop PE router 120 at an egress point from an ingress point router 120 on the edge where the message traffic (i.e. packet) entered the core network 102. The method aggregates, at a remote routing entity, forwarding state indicative of the next hop PE router based on the identified routing information 132, as depicted at step 201. Routing information is message traffic between routing entities (as distinguished from user data plane message traffic between user entities), often referred to as control plane information because it propagates routes between the switching entities in the network. In the example arrangement, the remote entity is the route controller 130 and network controller 140, however alternate configurations could be employed. In the example arrangement, the route controller receives the routing information in the form of control plane messages from the PE routers 120. The router controller 130 computes the forwarding information, and sends a subset to the network controller 140 for generating the forwarding state and programming the relevant PE routers 120 accordingly. The network controller 140 then programs he PE routers 120 with the forwarding state for forwarding packets to the next hop PE router 120 based on a computed route to a packet destination via the next hop PE router 120, as depicted at step 202.

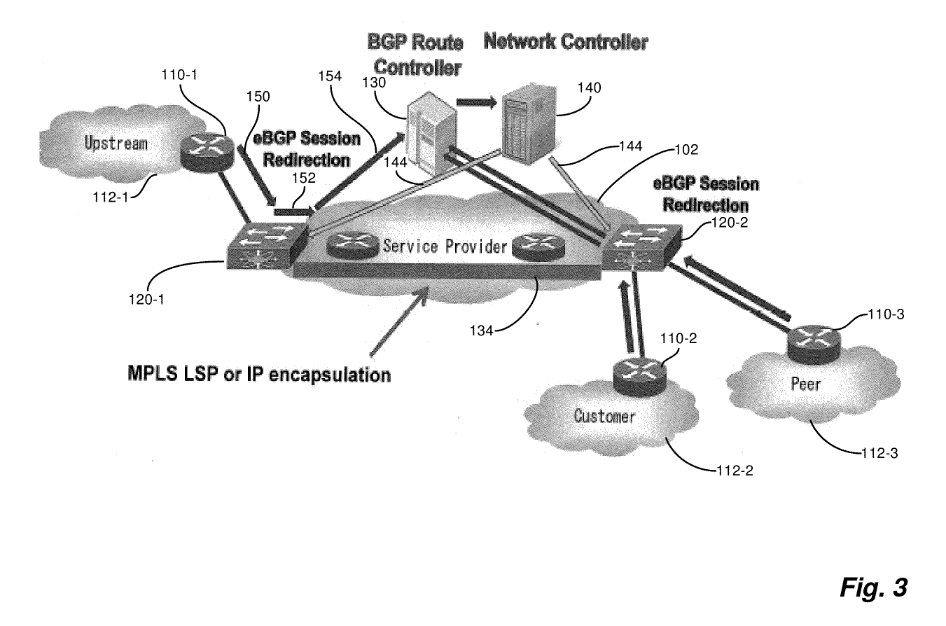

FIG. 3 is a block diagram of routing state data flow as in FIG. 2. Referring to FIGS. 2 and 3, in the example configuration, the control plane information conforms to the Border Gateway Protocol (BGP). Control plane messages 150 pertaining to BGP routing are identifiable by port, source, and/or destination, and the PE router 120-1 flags such messages for redirection, as shown by arrow 152. In the example configuration shown, the BGP route controller 130 is functionally similar to typical control plane route reflectors fully meshed between themselves with IBGP and peering to external EBGP peers. In addition, in order to further enhance the route controller's 130 plane robustness all paths should be exchanges between route controllers.

There are number of packaging alternatives for BGP route controllers 130 which would normally be an implementation choice. To illustrate the spectrum of such choices the RC may be delivered as a single machine, VM (virtual machine) or a an elastic cloud. Also it could contain and run single vendor's BGP stack or it could be designed to concurrently run multiple BGP implementations. One would observe that those design choices are not specific to BGP Free Edge configuration disclosed herein. They are equally applicable to control plane route reflectors in traditional IBGP domains.

It should be further noted that BGP Free Edge is generally applicable when the edge network element's forwarding plane is capable of being programmed by an external network controller 140. One of the mechanisms which can be used to program a network element can be accomplished by the use of OpenFlow protocol. The network controller is the focal point of the network applications. BGP is used as basic information/reachability distribution bus. When BGP is chosen to allocate and distribute the edge label, the focal point of the applications becomes shared between network controllers and BGP.

Configurations herein illustrate at least two applications which in the described architecture can be easily accomplished by use of BGP route controllers 130 and network controllers 140. One will be classic IPv4/IPv6 Internet service and the other one L3VPN [RFC4364] service. The L3VPN service will be realized as a simple virtualization of Internet service. Likewise Internet service can be just treated as one of the VPNs. It needs to be observed that for any of those applications VPN or Internet the notion of a so-called virtual-hub becomes very easy to deploy either centrally or on a POP by POP basis.

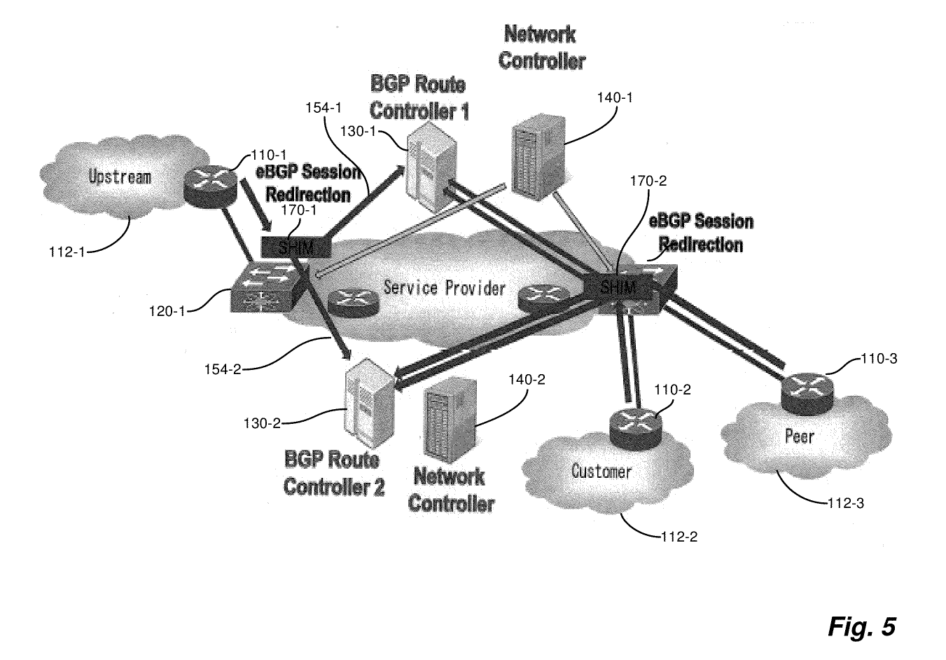

It should be further noted that the network controller 140 is operable to needs to program the edge network elements (i.e. PE routers 120) for special handling of BGP sessions. Such special handling may include direct forwarding to the BGP Route Controller or to the BGP SHIM (discussed below in FIG. 5) depending on operator choice. This approach allows the arriving EBGP sessions to be recognized and transparently redirected to the proper control plane element for further handling. The session handling and corresponding data plane state is programmed bidirectionally.

In the example arrangement, BGP messages correspond to port #179, and the control plane messages may also be identified by source and destination fields corresponding to the CE 110 and PE 120 routers, typically by a proactive match rule, however other mechanisms may be employed to flag the control plane messages 152.

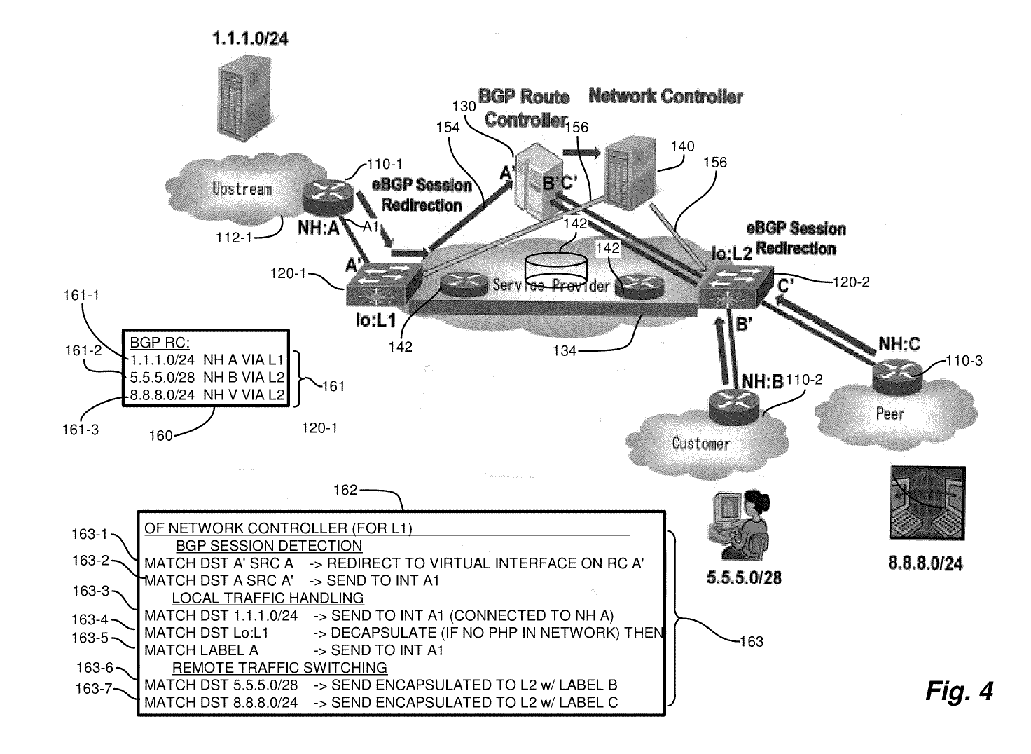

Upon redirection, shown by arrow 154, the route controller 130 receives the routing information message 132 to identify the next hop PE router, or path 134 between the PE routers 120 through the core 102 (discussed further below in FIG. 4). Aggregation of a plurality of the routing information messages 132 defines the control plane, or routing state, indicative of all forwarding decisions that the PE routers may receive packets predicated on. The network controller 140 receives the computed paths (routes) 132, and transmits routing information 144 to the respective PE routers 120 which define the ingress and egress points for routed message traffic.

FIG. 4 shows routing information computed for the data flow in FIG. 3. Referring to FIGS. 3 and 4, the route controller 130 receives the control plane messages (information) 154 and generates a next hop table 160 according to the border gateway protocol. Using the next hop information and the control plane messages 132, the network controller 140 receives a routing table 162 representing a subset of the redirected control plane information 154, for dissemination to the PE routers by programming from the network controller, as shown by arrows 156. In the example shown, the next hop table 160 and routing table 162 correspond to L1 (120-1).

The illustrated next hop table 160 has 3 entries 161-1 . . . 161-3, which denote that traffic addressed to 1.1.1.0 is transported to A (110-1) via PE router L1 (120-1), as depicted by entry 161-1. Entry 161-2 directs traffic for 5.5.5.0 to B (110-2) via L2 (110-2), and entry 161-3 directs traffic addressed to 8.8.8.0 to C (110-3), also via L2.

The resulting routing table 162 at L1 depicts 7 entries 163-1 . . . 163-7. BGP session detection messages directed to A′ (120-1) from A (110-1) are redirected to the route controller 130, shown by arrow 154 and entry 163-1. In the opposite direction, message traffic to A (110-1) is sent to interface A1 (at CE router 110-1), by entry 163-2. For local traffic handling, entry 163-3 directs message traffic for 1.1.1.0 to interface A1 (110-1). Message traffic to L1 is decapsulated as directed by entry 163-4, and entry 163-5 directs traffic for A (110-1) to interface A1. Remote traffic switching is handled by entry 163-6 for invoking the path 134 to L2 (120-2) for label B for CE router 110-2, and entry 163-7 directs label C also to L2 for delivery to CE router 110-3.

FIG. 5 shows a shim employed in the configuration of FIG. 4. Referring to FIGS. 4 and 5, a shim 170-1 . . . 170-2 (170 generally) adds a measure of redundancy by distributing the control plane information to a plurality of route controllers 130-1 . . . 130-2 and 140-1 . . . 140-2. Using the same rule matching as depicted by the routing table 162, the shim 170 identifies the control plane information as matched by entry 163-1, and redirects to both route controllers 130-1 and 130-2 for propagation by network controllers 140-1 and 140-2. The shim 170-2 at shim 120-2 performs similar failover redundancy for the control plane traffic at PE router 120-2.

FIG. 5 shows a shim employed in the configuration of FIG. 4. The introduction of a shim 170-1 . . . 170-2 (170 generally) introduces a measure of redundancy and replication, in which network robustness is compromised by any new network architecture and the ability to replicate information received from EBGP peers to redundant control plane clusters becomes a significant requirement.

There are several solutions on how such replication can be accomplished. Both employ introduction of independent to the edge switch or router “shim module” which primarily will terminate received EBGP session and establish set of new EBGP sessions towards the BGP route controllers 130. Configurations herein disclose a BGP shim 170 architecture which avoids parsing of BGP Update Messages or any other future BGP “data” messages. However, it should be able to parse BGP OPEN messages, BGP Route Refresh Messages as well as for performance optimization it is recommended to also be able to handle BGP Keepalives and BGP BFD messages. If needed, it may also handle BGP BMP [I-D.ietf-grow-bmp] massages.

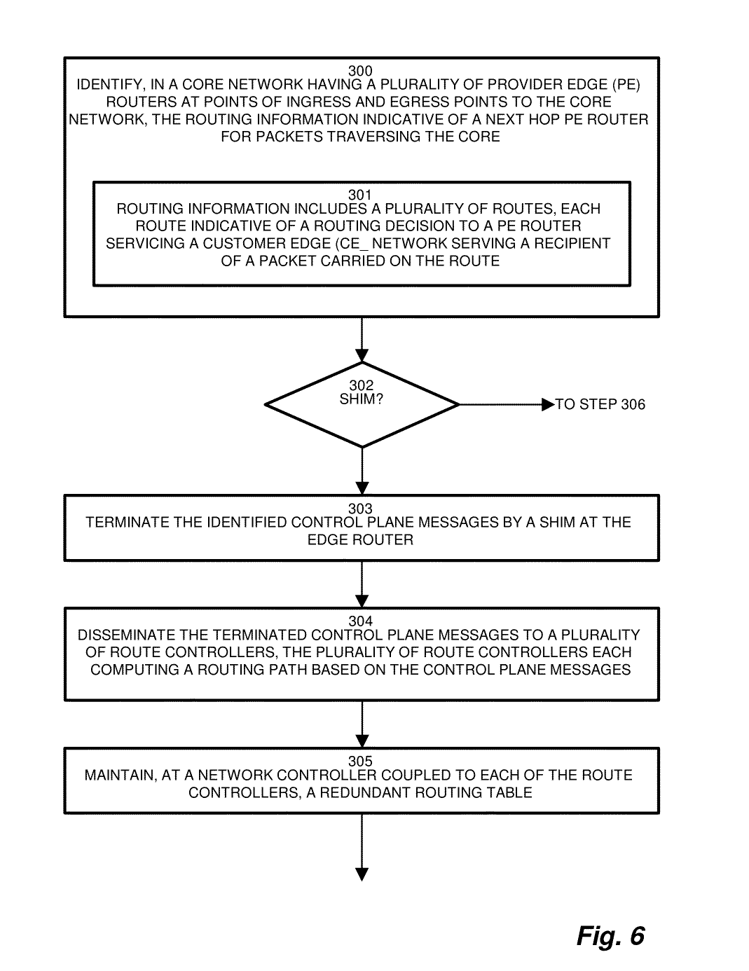

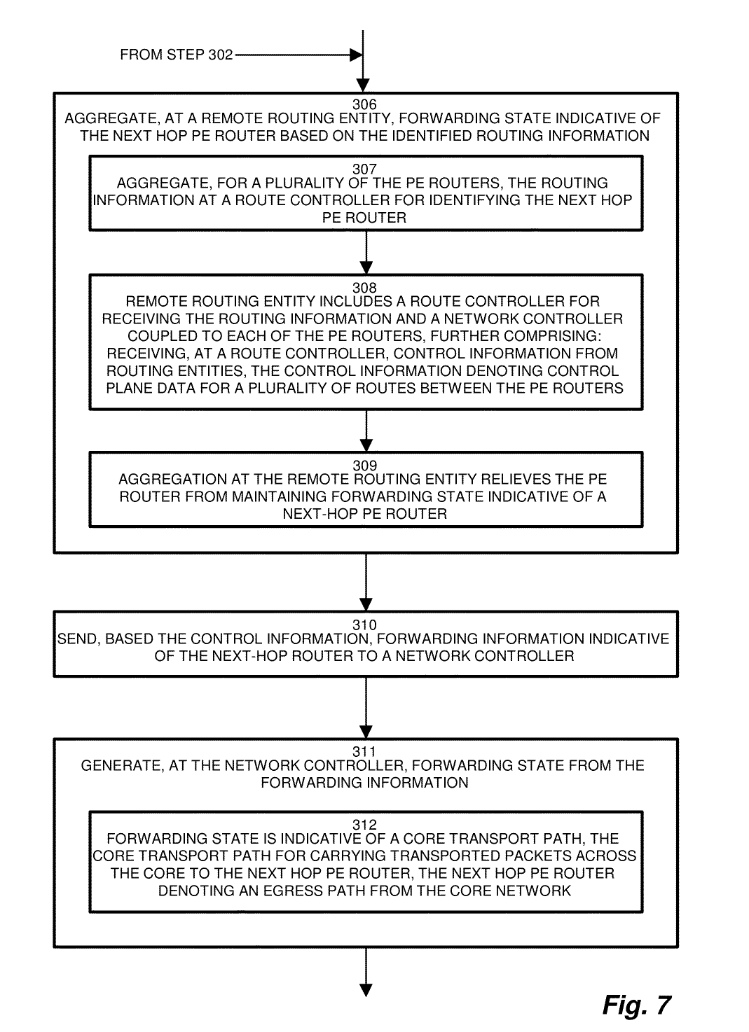

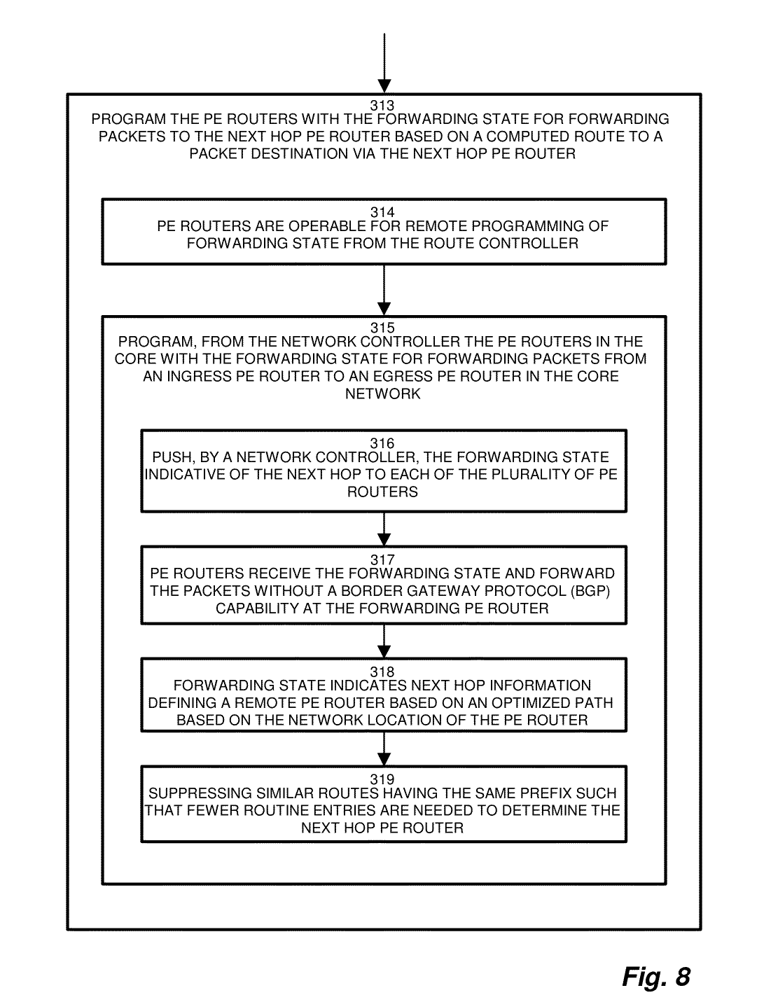

FIGS. 6-8 are a flowchart of routing state as in FIGS. 3-5. Referring to FIGS. 1 and 3-8, the method for storing routing state information includes identifying, in a core network 102 having a plurality of provider edge (PE) routers 120 at points of ingress and egress points to the core network 102, the routing information indicative of a next hop PE router for packets traversing the core 102, as depicted at step 300. The routing information 154 includes a plurality of routes, such that each route is indicative of a routing decision to a PE router 120 servicing a customer edge (CE) network 112 serving a recipient of a packet carried on the route, as shown at step 301.

A check is performed at step 302, to identify if a shim 170 is employed, an if so, the shim 170 terminates the identified control plane messages 132 by the shim 170 at the edge router 120, as shown at step 303, and disseminates the terminated control plane messages to a plurality of route controllers 130, such that the plurality of route controllers 130 each compute a routing path to an egress PE router 120 based on the control plane messages 132, as disclosed at step 304. Via the shim 170, the network controller 140 therefore maintains, at the network controller 140 coupled to each of the route controllers 130, a redundant routing table, as depicted at step 305.

A remote routing entity aggregates the forwarding state indicative of the next hop PE router based on the identified routing information 154, as shown at step 306. In the example configuration, this includes, at step 307, aggregating, for a plurality of the PE routers 120, the routing information 154 at the route controller for identifying the next hop PE router 120, as depicted at step 307. The remote routing entity therefore includes a route controller 130 for receiving the routing information 154 and a network controller 140 coupled to each of the PE routers, for receiving, at the route controller 130, control information 132 from routing entities 120, in which the control information 132 denotes control plane data for a plurality of routes between the PE routers 120, as depicted at step 308. The aggregation at the remote routing entity (network controller 140 and route controller 130) therefore relieves the PE router 132 from maintaining forwarding state indicative of a next-hop PE router 120, as disclosed at step 309.

The route controller 130 sends, based the control information 132, forwarding information indicative of the next-hop router to the network controller 140, as depicted at step 310. The network controller 140 then generates the forwarding state 144 from the forwarding information, as shown at step 311. In the example arrangement, the forwarding state 144 is indicative of a core transport path, the core transport path for carrying transported packets across the core to the next hop PE router, the next hop PE router denoting an egress path from the core network, as depicted at step 312.

The network controller(s) 140 programming the PE routers 120 with the forwarding state 144 for forwarding packets to the next hop PE router 120 based on a computed route to a packet destination via the next hop PE router, as shown at step 313. In the example arrangement, the PE routers 120 are operable for remote programming of forwarding state from the network controller 140, as depicted at step 314. This includes, at step 315, programming, from the network controller 140, the PE routers 120 in the core 102 edge with the forwarding state 144 for forwarding packets from an ingress PE router to an egress PE router in the core network 102, as depicted at step 315. This involves pushing, by the network controller 140, the forwarding state 144 indicative of the next hop to each of the plurality of PE routers 120, as shown at step 316, and may involve one or more of the following optimizations. In particular arrangements, the PE routers 120 receive the forwarding state and forward the packets without a border gateway protocol (BGP) capability at the forwarding PE router 120, simplifying hardware deployment, as shown at step 317. The forwarding state 144 indicates next hop information defining a remote PE router 120 based on an optimized path based on the network location of the PE 120, as shown at step 318. Further, arrangements suppress more specific routes having the same prefix such that fewer routing entries are needed to determine the next hop PE router, as depicted at step 319.

It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

What is claimed is:

1. A method for storing routing state information comprising:
identifying, in a core network having a plurality of provider edge (PE) routers at ingress and egress points to the core network, the routing information indicative of a next hop PE router for packets traversing the core;
aggregating, at a remote routing entity, forwarding state indicative of the next hop PE router based on the identified routing information; and
programming the PE routers with the forwarding state for forwarding packets to the next hop PE router based on a computed route to a packet destination via the next hop PE router.

2. The method of claim 1 the remote routing entity includes a route controller for receiving the routing information and a network controller in communication with each of the PE routers for programming routes, further comprising:
receiving, at a route controller, control information from routing entities, the control information denoting control plane data for a plurality of routes between the PE routers;
sending, based the control information, forwarding information indicative of the next-hop router to a network controller;
generating, at the network controller, forwarding state from the forwarding information; and
programming, from the network controller the PE routers in the core with the forwarding state for forwarding packets from an ingress PE router to an egress PE router in the core network.

3. The method of claim 1 further comprising:
aggregating, for a plurality of the PE routers, the routing information at a route controller for identifying the next hop PE router; and
pushing, by a network controller, the forwarding state indicative of the next hop to each of the plurality of PE routers.

4. The method of claim 3 wherein the routing information includes a plurality of routes, each route indicative of a routing decision for directing packets to a PE router servicing a customer edge (CE) router serving a recipient of the packet carried on the route.

5. The method of claim 3 further comprising:
terminating the identified control plane messages by a shim at the edge router;
disseminating the terminated control plane messages to a plurality of route controllers, the plurality of route controllers each computing a routing path based on the control plane messages; and
maintaining, at a network controller coupled to each of the route controllers, a redundant routing table.

6. The method of claim 1 wherein the forwarding state is indicative of a core transport path, the core transport path for carrying transported packets across the core to the next hop PE router, the next hop PE router denoting an egress path from the core network.

7. The method of claim 6 wherein the aggregation at the remote routing entity relieves the PE router from maintaining forwarding state indicative of a next-hop PE router.

8. The method of claim 7 wherein the PE routers receive the forwarding state and forward the packets without a border gateway protocol (BGP) capability at the forwarding PE router.

9. The method of claim 2 wherein the PE routers are operable for remote programming of forwarding state from the network controller.

10. The method of claim 3 wherein the forwarding state indicates next hop information defining a remote PE router based on an optimized path based on the network location of the PE.

11. The method of claim 10 further comprising suppressing more specific routes having the same prefix such that fewer routing entries are needed to determine the next hop PE router.

12. A network controller configured for storing routing state information comprising:
an interface to a plurality of PE routers for identifying, in a core network having a plurality of provider edge (PE) routers at ingress and egress points to the core network, the routing information indicative of a next hop PE router for packets traversing the core;
the interface responsive to aggregating, at a remote routing entity, forwarding state indicative of the next hop PE router based on the identified routing information; and
programming logic for programming the PE routers with the forwarding state for forwarding packets to the next hop PE router based on a computed route to a packet destination via the next hop PE router.

13. The network controller of claim 12 wherein the remote routing entity includes a route controller for receiving the routing information and a network controller coupled to each of the PE routers, further comprising:
an interface for receiving, at the route controller, control information from routing entities, the control information denoting control plane data for a plurality of routes between the PE routers;
forwarding logic for computing and sending, based the control information, forwarding information indicative of the next-hop router to a network controller, the network controller responsive to the forwarding logic for generating, at the network controller, forwarding state from the forwarding information; and
the logic further operable for programming, from the network controller, the PE routers in the core with the forwarding state for forwarding packets from an ingress PE router to an egress PE router in the core network.

14. The network controller of claim 12 wherein the remote routing entity is further operable to:
aggregate, for a plurality of the PE routers, the routing information at a route controller for identifying the next hop PE router, and
push, by a network controller, the forwarding state indicative of the next hop to each of the plurality of PE routers.

15. The network controller of claim 14 further comprising a route controller, wherein the routing information includes a plurality of routes, each route indicative of a routing decision to a PE router servicing a customer edge (CE) network serving a recipient of a packet carried on the route

16. The network controller of claim 14 further comprising a route controller having an interface to a shim, the shim operable to:
terminate the identified control plane messages by the shim at the edge router;
disseminate the terminated control plane messages to a plurality of route controllers, the plurality of route controllers each computing a routing path based on the control plane messages; and
maintain, at a network controller coupled to each of the route controllers, a redundant routing table.

17. The network controller of claim 16 wherein the forwarding state is indicative of a core transport path, the core transport path for carrying transported packets across the core to the next hop PE router, the next hop PE router denoting an egress path from the core network.

18. The network controller of claim 12 wherein the aggregation at the remote routing entity relieves the PE router from maintaining forwarding state indicative of a next-hop PE router.

19. A computer program product encoded as instructions on a non-transitory computer readable storage medium for performing a method of storing routing state information, the method comprising:
identifying, in a core network having a plurality of provider edge (PE) routers at ingress and egress points to the core network, the routing information indicative of a next hop PE router for packets traversing the core;
aggregating, at a remote routing entity, forwarding state indicative of the next hop PE router based on the identified routing information, aggregation at the remote routing entity relieving the PE router from maintaining forwarding state indicative of a next-hop PE router; and
programming the PE routers with the forwarding state for forwarding packets to the next hop PE router based on a computed route to a packet destination via the next hop PE router.

20. The computer program of claim 19 wherein the remote routing entity includes a route controller for receiving the routing information and a network controller coupled to each of the PE routers, the method further comprising:
receiving, at a route controller, control information from routing entities, the control information denoting control plane data for a plurality of routes between the PE routers;
sending, based the control information, forwarding information indicative of the next-hop router to a network controller;
generating, at the network controller, forwarding state from the forwarding information; and
programming, from the network controller the PE routers in the core with the forwarding state for forwarding packets from an ingress PE router to an egress PE router in the core network.
